(19) United States
(12) Patent Application Publication
(10) Pub. No.: US 2015/0019181 A1
(43) Pub. Date: Jan. 15, 2015

(54) Estimation of NOx Generation in A Commercial Pulverized Coal Burner using a Dynamic Chemical Reactor Network Model

(71) Applicant: Siemens Aktiengesellschaft, Munich (DE)

(72) Inventors: Lu Wang, Houston, TX (US); Zhixuan Duan, Plainsboro, NJ (US); Chao Yuan, Plainsboro, NJ (US); Yu Sun, Plainsboro, NJ (US); Amit Chakraborty, East Windsor, NJ (US)

(21) Appl. No.: 14/325,862

(22) Filed: Jul. 8, 2014

Related U.S. Application Data
(60) Provisional application No. 61/846,185, filed on Jul. 15, 2013.

(51) Int. Cl. G06F 19/00

(52) U.S. Cl. CPC G06F 19/702; G06F 19/707
USPC 703/2

(57) ABSTRACT

NOx generation in a coal burning furnace is estimating using a chemical reactor network model. The model is constructed with ideal chemical reactor modules, an input matrix and a tunable parameter matrix defining split ratios and flow rates among the ideal chemical reactor modules. Values in the tunable parameter matrix are learned by first measuring actual furnace outputs of the coal burning furnace for a known set of actual furnace inputs, and then applying the chemical reactor network, including an initially populated tunable parameter matrix, to a populated input matrix representing the known set of actual furnace inputs. The actual furnace outputs are compared with the output matrix, and the tunable parameter matrix is adjusted based on the comparison.

### CROSS-REFERENCE TO RELATED APPLICATIONS

This application claims the benefit under 35 U.S.C. §119(e) of U.S. Provisional Patent Application No. 61/846,185 entitled ESTIMATION OF NOx GENERATION IN A COMMERCIAL PULVERIZED COAL BURNER USING A DYNAMIC CHEMICAL REACTORS NETWORK MODEL, filed on Jul. 15, 2013, which is incorporated herein by reference in its entirety and to which this application claims the benefit of priority.

### BACKGROUND OF THE INVENTION

1. Field of the Invention

The invention relates to the mathematical modeling of chemical processes. More particularly, the invention relates to the modeling of a coal burning process in order to predict concentrations of nitrogen oxide (NOx) gases in the process effluent.

2. Description of the Prior Art

Pulverized coal furnaces are presently in wide use. NOx emissions from coal furnaces largely originate from oxidation of the nitrogen atoms in the fuel itself, as opposed to atmospheric nitrogen. Pulverized coal burners of advanced design may reduce emissions of nitrogen oxides by a factor of 2 to 3 from uncontrolled combustion systems by staging the addition of oxygen to produce an initially fuel-rich regime in which the bound nitrogen is partially converted to N2.

The capability to predict and estimate effluent components has become critical in the design and operation of those coal furnaces. One important problem is the monitoring of NOx formation during the combustion process inside the furnace. It is currently not possible to measure temperature and NOx concentration inside the furnace during the combustion reactions. Indirect methods are therefore used. For example, computational fluid dynamics (CFD) simulation may be used to model the combustion reactions. That technique is typically too time-consuming to be practical in real applications.

Another technique for monitoring temperature and NOx concentration is the use of a chemical reactor network (CRN) to model the reaction. The creation of a CRN, often guided by CFD, gives insight into the complex phenomena that occur within the combustion chamber and are otherwise not measurable. A CRN model is constructed as a series of ideal reactors, connected with each other according to certain split ratios and flow rates. Currently, those parameters connecting one reactor to the others are determined by users' experience. The results are therefore dependent in large measure on the estimation of the algorithm parameters that are used.

Thus, a need exists in the art for a technique for accurately monitoring temperature and NOx concentration within a pulverized coal furnace.

An additional need exists for a useable procedure for building a chemical reactor network for use in accurately monitoring temperature and NOx concentration within a pulverized coal furnace.

Another need exists in the art for building a chemical reactor network including ideal reactors interconnected by tunable parameters that are established without reliance on the expertise of the users.

### SUMMARY OF THE INVENTION

An object of embodiments of the invention is to accurately and efficiently monitor temperature and NOx concentration within a pulverized coal furnace without the time-consuming process of building a complete CFD model. Another object is to build a chemical reactor network for monitoring NOx concentration without relying on the expertise of the users for the determination of tunable parameters interconnecting the ideal reactor modules.

An additional object of the present disclosure is the creation of a chemical reactor network for monitoring NOx concentration that includes a tunable mapping model with parameters that are learned by comparing a model output with measurements of actual furnace conditions.

These and other objects are achieved in one or more embodiments of the invention in which a machine learning algorithm is used to learn the mapping model between the tunable parameters and the status of each point inside the furnace. The model is used to tune the parameters with existing measurements to predict furnace status using customers' input values. By using the machine learning model instead of the traditional CFD and CRN models, the temperature and NOx concentration inside the furnace is monitored and predicted more accurately and efficiently.

In embodiments of the present disclosure, a method is provided for estimating NOx generation in a coal burning furnace. The method includes measuring actual furnace outputs of the coal burning furnace, including NOx generation, for a known set of actual furnace inputs. A chemical reactor network is then constructed. The network comprises a plurality of ideal reactor modules, an input matrix defining chemical reactor network inputs, and a tunable parameter matrix defining split ratios and flow rates among the plurality of ideal reactor modules. The chemical reactor network, including an initially populated tunable parameter matrix, is then applied to a populated input matrix representing the known set of actual furnace inputs, to create an output matrix including an estimate of NOx generation. The actual furnace outputs are compared with the output matrix, and, based on the comparison, an adjusted tunable parameter matrix is created.

In other embodiments, the chemical reactor network inputs include concentrations of compositions in coal. In other embodiments, the chemical reactor network inputs include input air temperature and flow rate. In further embodiments, the output matrix further includes volumetric flow rate and temperature. In certain embodiments, the tunable parameter matrix further defines volumes of the ideal reactor modules.

In some embodiments, adjusting the tunable parameter matrix comprises grid searching for a best tunable parameter matrix. The best tunable parameter matrix may be a tunable parameter matrix yielding an output matrix having a smallest least squared error in comparison to the actual furnace outputs.

Some embodiments include repeating the operation of applying the chemical reactor network using the adjusted tunable parameter matrix. Constructing a chemical reactor network may be performed under an assumption that coal devolatilization depends only on coal composition and heating rate, and that coal distributions are equal for a given set of gas burners, and that air is distributed equally among a given set of air ports.

In other embodiments, a system is provided for estimating NOx generation in a coal burning furnace. The system includes a processor and an interface connected to the processor and connected to receive measurements of actual furnace outputs of the coal burning furnace, including NOx generation, for a known set of actual furnace inputs. The system additionally includes computer readable media containing computer readable instructions that, when executed by the processor, cause the processor to perform a number of operations. Those operations include constructing a chemical reactor network comprising a plurality of ideal reactor modules, an input matrix defining chemical reactor network inputs, and a tunable parameter matrix defining split ratios and flow rates among the plurality of ideal reactor modules. The operations further include applying the chemical reactor network, including an initially populated tunable parameter matrix, to a populated input matrix representing the known set of actual furnace inputs, to create an output matrix including an estimate of NOx generation; making a comparison of the actual furnace outputs with the output matrix; and, based on the comparison, creating an adjusted tunable parameter matrix.

The respective objects and features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 is a diagrammatic illustration of an effluent and temperature estimation technique, in accordance with embodiments of the invention;

FIG. 2 is a symbolic representation of an example chemical reactor network, in accordance with embodiments of the invention;

FIG. 3 is a schematic diagram of a pulverized coal furnace to be monitored in accordance with aspects of the invention.

To facilitate understanding, identical reference numerals have been used, where possible, to designate identical elements that are common to the figures.

### DETAILED DESCRIPTION

Presently disclosed is a machine-learning-based solution to monitor and predict the temperature and NOx concentration inside a pulverized coal furnace. The disclosed technique is very efficient, quickly generating the predicted values of temperature and concentration of selected species (specifically NOx). The technique furthermore is adaptable to various inputs, including variability in the coal supply over time. Details of the structure of the model and operations in creating the model and predicting algorithm are set forth below.

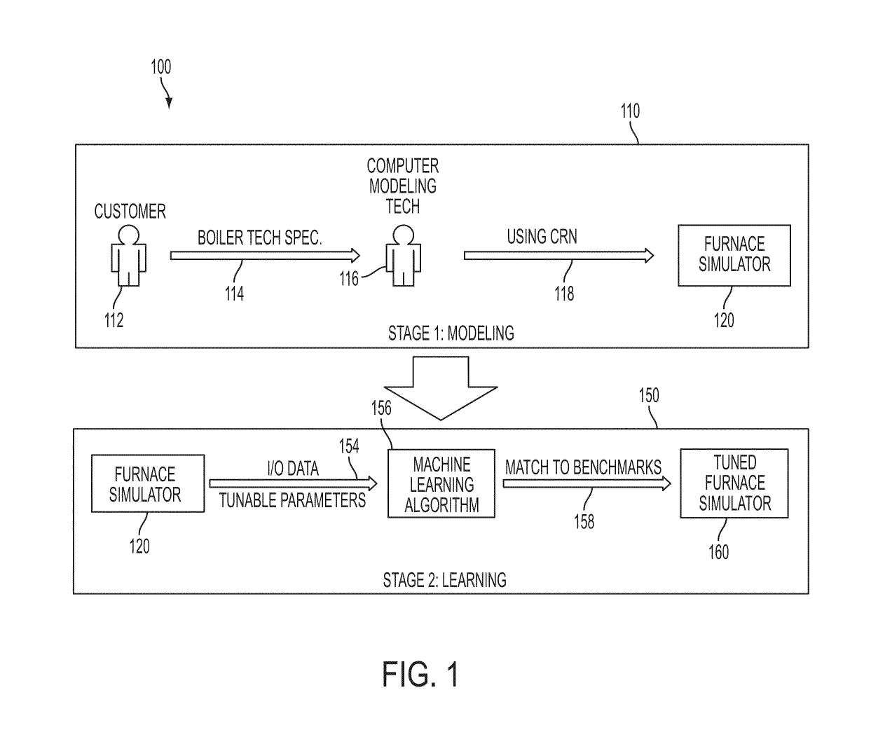

An overview of the disclosed effluent and temperature estimation technique, shown as a diagrammatic representation 100 in FIG. 1, includes a modeling stage 110 and a learning stage 150. To create the initial model, a customer 112 initially provides technical specifications 114 such as boiler specifications and furnace specifications. The specifications may include furnace geometry, burner locations and various operating parameters of the furnace. A computer modeling technician 116 then formulates a furnace simulator 120 using chemical reactor network techniques 118. The simulator includes a plurality of ideal chemical reactor modules, including plug flow reactors and perfectly stirred reactors, interconnected by tunable parameters. The computer modeling technician may be guided by a CFD analysis of the furnace based on the specifications. The CRN furnace simulator 120 provides a detailed representation of the emissions formation pathways, and may take into account mixing patterns that were discovered using the CFD analysis of the furnace.

The chemical reactor network methodology simulates complex chemical mechanisms with a network of ideal reactor models. It can provide significant insight into pollutant formation pathways. Because of its small computational cost, the CRN can be used as tool for analysis of combustion systems by coupling with a flow pattern obtained either from CFD simulation or direct measurement.

In the learning stage 150, the furnace simulator 120 is run using a known set of input data and an initial set of tunable parameters 154. Output from the simulator, including NOx predictions, are input to a machine learning algorithm 156, together with the input data and the initial set of tunable parameters. The machine learning algorithm compares the simulator output with measured benchmarks resulting from the real inputs represented by the known set of input data. The furnace simulator is then tuned 160 by adjusting the tunable parameters to match the simulator output with the benchmark measurements.

The resulting system simulates the furnace status more accurately and efficiently than the traditional CRN model. The effectiveness of any CRN model in simulating the temperature and species concentrations inside the furnace is strongly tied to how the ideal reactors in CRN are connected. Those connections have, in the past, been based primarily on technicians' intuition and experience. The presently disclosed technique uses a machine learning approach to tune the connection parameters to improve the estimates made by the network. With that machine learning approach, the CRN model is tuned and available for accurately predicting furnace status output based on customers' input values in a few seconds instead of a few hours for a traditional CRN and a few days for a CFD.

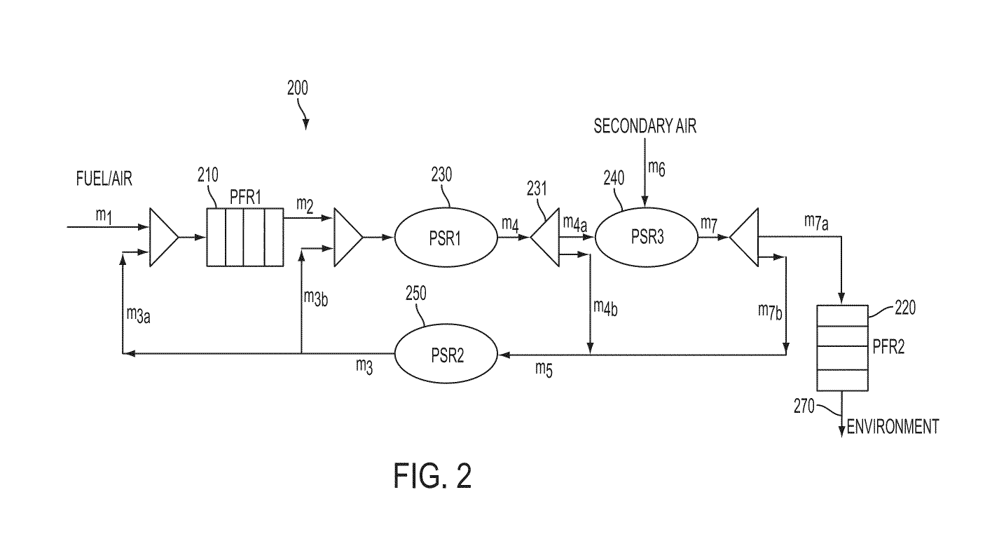

An example 200 of a CRN model for a natural gas furnace is shown in FIG. 2. The model comprises several ideal reactor models, including plug flow reactor models 210, 220 and perfectly stirred reactor models 230, 240, 250. A plug flow reactor model describes a chemical reaction in a continuous, flowing system having a cylindrical geometry. A perfectly stirred reactor model assumes perfect mixing and the contents are assumed to be nearly spatially uniform due to high diffusion rates. The rate of conversion of reactants to products in a perfectly stirred reactor model is controlled by chemical reaction rates and not by mixing processes.

The plug flow reactor models 210, 220 and perfectly stirred reactor models 230, 240, 250 are interconnected by a plurality of tunable parameters including split ratios and flow rates. For example, the output flow rate m₄ from the perfectly stirred reactor 230 is split according to a split ratio 231 into flows m₄ₐ and m_{4b}. The tunable parameters are stored in a tunable parameter matrix Z.

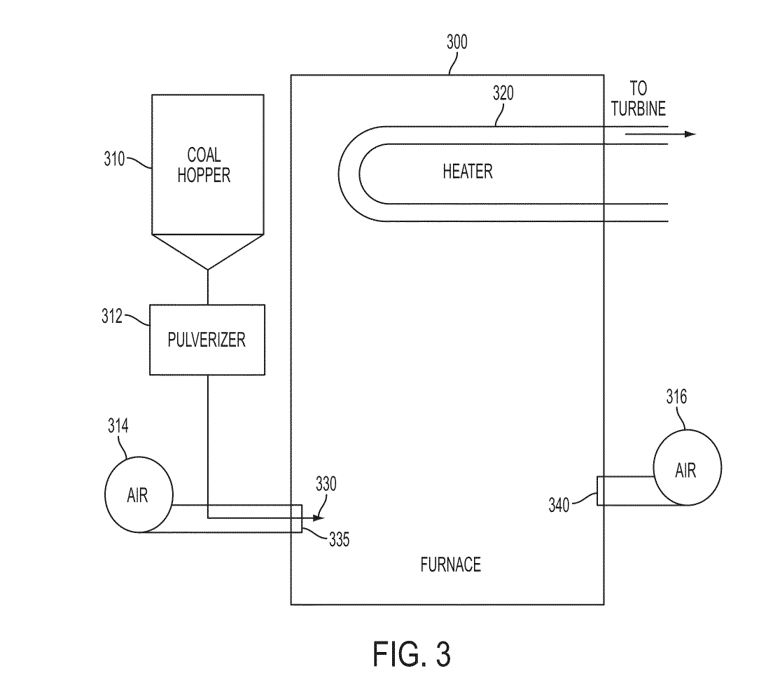

A typical pulverized coal furnace, such as the furnace 300 shown in FIG. 3, includes one or more coal burners 330 fed by a coal source 310 through a pulverizer 312. One or more primary air ports 335 provide oxygen at the flame location from a blower or compressor 314. The furnace may also have one or more secondary air ports such as port 340 supplied by blower 316. Heat from the burners superheats steam in a heater arrangement 320.

Inputs to the CRN model 200 (FIG. 2) include inputs at each coal burner and inputs at each air port. Inputs to the CRN model that can be measured or determined at each coal burner include the volumetric flow rate of the air/fuel mixture, the temperature and the concentration of major compositions in the coal. Inputs to the CRN model that can be measured or determined at each air port include the volumetric flow rate and the temperature of the air.

The example CRN model 200 therefore also includes a fuel/air input having a flow rate m₁ and a secondary air input having a flow rate m₆. An input table containing such variables is denoted as a matrix X. Input variables may be included in the input table as follows:

| | At each Coal | At each Air |
|---|---|---|
| Input | Burner | Port |
| Volumetric | Yes | Yes |
| flow rate | | |
| Temperature | Yes | Yes |
| Concentration | Yes | NA |
| of major | | |
| compositions | | |
| of the coal | | |

The example CRN model 200 further includes an output 270 to the environment. An output table containing output variables is denoted as a matrix Y. The variables may include the following:

| | At each grid |
|---|---|
| | throughout the |
| Output | furnace |
| Volumetric flow rate | Yes |
| Temperature | Yes |
| Concentration of CO | Yes |
| and NOx | |

The focus of the present disclosure is on a tunable parameter matrix Z, which is the collection of split ratios and flow rates among ideal reactors in the chemical reactor network. The matrix Z may also include tunable volumes of the individual ideal reactors. Based on the variables defined above, several assumptions regarding the reaction simulation system may be made:
1. Coal devolatilization depends on coal composition and heating rate only.
2. Coal distributions are equal for a given set of gas burners.
3. Air is distributed equally among a given set of air ports.

After generating the furnace status output using the user's input and algorithm parameters using CRN model, a learning algorithm is used to teach the model to map this relationship. With the above assumptions and set-up, the machine learning model predicts the output variables at each grid point in the furnace based on the input variables:

Y=f(X, Z)+ε

The error ε accounts for noise in the system, including measurement errors and process variability. After learning the CRN simulated result, it is possible to find the model f ( ) that maps the furnace input and tunable parameters in the system with the output. The fixed mapping model f ( ) is then used to tune the parameters in Z to match the output result to real measurements. That is to say, find Z* that makes Y*=f (X, Z*), Y* being the benchmark values measured by analysis of the actual process effluent, such as by using a laser spectroscopic device.

Since the tunable parameters in Z are mostly split ratios in the range of [0, 1] and flow rates and reactor volumes in proper ranges, grid-searching is an effective technique for finding Z*. Grid-searching is an exhaustive searching method in which each dimension of the parameter space is divided into a number of segments. In the presently described application of grid searching, the possible ranges for each split ratio, each flow rate and each reactor volume are divided into segments. Every combination of the parameter values in the given ranges is then tried, to find the combination that has the smallest mean squared error as compared with the benchmark measurement.

While grid searching has been found to perform well in the presently described technique, it is an exhaustive and therefore potentially expensive method. Alternatives may be employed in cases with particularly complicated chemical reactor networks. For example, a randomized search may be used that randomly samples parameter settings a fixed number of times.

The process may be repeated, using the tuned parameter matrix Z*, to further refine the results. With the tuned parameter matrix Z*, the CRN model simulates the combustion process in coal furnace more accurately and efficiently than prior CRN models.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The exemplary CRN model is are shown by way of illustration and not by way of limitation, to clearly describe certain features and aspects of the present invention set out in greater detail herein. However, the various aspects of the present invention described more fully herein may be applied to various combustion engines to monitor and/or detect the occurrence of combustion anomalies. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A method for estimating NOx generation in a coal burning furnace, comprising:
measuring actual furnace outputs of the coal burning furnace, including NOx generation, for a known set of actual furnace inputs;
constructing a chemical reactor network comprising:
a plurality of ideal reactor modules;
an input matrix defining chemical reactor network inputs; and
a tunable parameter matrix defining split ratios and flow rates among the plurality of ideal reactor modules;
applying the chemical reactor network, including an initially populated tunable parameter matrix, to a populated input matrix representing the known set of actual furnace inputs, to create an output matrix including an estimate of NOx generation;
making a comparison of the actual furnace outputs with the output matrix;
based on the comparison, creating an adjusted tunable parameter matrix.

2. The method of claim 1, wherein the chemical reactor network inputs include concentrations of compositions in coal.

3. The method of claim 1, wherein the chemical reactor network inputs include input air temperature and flow rate.

4. The method of claim 1, wherein the output matrix further includes volumetric flow rate and temperature.

5. The method of claim 1, wherein the tunable parameter matrix further defines volumes of ideal reactor modules.

6. The method of claim 1, wherein adjusting the tunable parameter matrix comprises grid searching for a best tunable parameter matrix.

7. The method of claim 6, wherein the best tunable parameter matrix is a tunable parameter matrix yielding an output matrix having a smallest least squared error in comparison to the actual furnace outputs.

8. The method of claim 1, wherein the method further comprises:
repeating the operation of applying the chemical reactor network, using the adjusted tunable parameter matrix.

9. The method of claim 1, wherein constructing a chemical reactor network is performed under an assumption that coal devolatilization depends only on coal composition and heating rate.

10. The method of claim 1, wherein constructing a chemical reactor network is performed under assumptions that coal distributions are equal for a given set of gas burners, and that air is distributed equally among a given set of air ports.

11. A system for estimating NOx generation in a coal burning furnace, comprising:
a processor;
an interface connected to the processor and connected to receive measurements of actual furnace outputs of the coal burning furnace, including NOx generation, for a known set of actual furnace inputs;
computer readable media containing computer readable instructions that, when executed by the processor, cause the processor to perform the following operations:
constructing a chemical reactor network comprising:
a plurality of ideal reactor modules;
an input matrix defining chemical reactor network inputs; and
a tunable parameter matrix defining split ratios and flow rates among the plurality of ideal reactor modules;
applying the chemical reactor network, including an initially populated tunable parameter matrix, to a populated input matrix representing the known set of actual furnace inputs, to create an output matrix including an estimate of NOx generation;
making a comparison of the actual furnace outputs with the output matrix;
based on the comparison, creating an adjusted tunable parameter matrix.

12. The system of claim 11, wherein the chemical reactor network inputs include concentrations of compositions in coal.

13. The system of claim 11, wherein the chemical reactor network inputs include input air temperature and flow rate.

14. The system of claim 11, wherein the output matrix further includes volumetric flow rate and temperature.

15. The system of claim 11, wherein the tunable parameter matrix further defines volumes of ideal reactor modules.

16. The system of claim 11, wherein adjusting the tunable parameter matrix comprises grid searching for a best tunable parameter matrix.

17. The method of claim 16, wherein the best tunable parameter matrix is a tunable parameter matrix yielding an output matrix having a smallest least squared error in comparison to the actual furnace outputs.

18. The system of claim 11, wherein the operations further comprise:
repeating the operation of applying the chemical reactor network, using the adjusted tunable parameter matrix.

19. The system of claim 11, wherein constructing a chemical reactor network is performed under an assumption that coal devolatilization depends only on coal composition and heating rate.

20. The method of claim 11, wherein constructing a chemical reactor network is performed under assumptions that coal distributions are equal for a given set of gas burners, and that air is distributed equally among a given set of air ports.
